(19) United States
(12) Patent Application Publication
(10) Pub. No.: US 2016/0103209 A1
(43) Pub. Date: Apr. 14, 2016

(54) IMAGING DEVICE AND THREE-DIMENSIONAL-MEASUREMENT DEVICE

(71) Applicant: FUJIFILM Corporation, Tokyo (JP)

(72) Inventors: Tomonori MASUDA, Saitama-shi (JP); Hiroshi TAMAYAMA, Saitama-shi (JP); Mikio WATANABE, Saitama-shi (JP); Eiji ISHIYAMA, Saitama-shi (JP); Daisuke HAYASHI, Saitama-shi (JP); Sugio MAKISHIMA, Saitama-shi (JP)

(73) Assignee: FUJIFILM Corporation, Tokyo (JP)

(21) Appl. No.: 14/972,292

(22) Filed: Dec. 17, 2015

Related U.S. Application Data
(63) Continuation of application No. PCT/JP2014/066651, filed on Jun. 24, 2014.

(30) Foreign Application Priority Data
Jul. 16, 2013 (JP) 2013-147636

(51) Int. Cl. G01S 7/48; G01S 17/89; G01S 17/42

(52) U.S. Cl. CPC G01S 7/4808; G01S 17/42; G01S 17/89

(57) ABSTRACT

A laser ranging unit is rotatably attached to a camera body by a hinge unit. The camera body has a first imaging unit and a laser radiation position specification unit. The laser ranging unit has a laser radiation unit, a laser receiving unit, a second imaging unit, and a distance calculation unit. The first imaging unit images a first range to generate a first image. The laser radiation unit is able to radiate a laser beam in an arbitrary direction within the first range. The laser receiving unit receives a reflected beam of the laser beam. The second imaging unit images a second range including a radiation position of the laser beam within the first range to generate a second image. The laser radiation position specification unit searches for a portion matching the second image in the first image to specify the radiation position in the first image. The distance calculation unit calculates the distance to the radiation position based on the time of receiving the reflected beam.

### CROSS-REFERENCE TO RELATED APPLICATIONS

This application is a Continuation of PCT International Application No. PCT/JP2014/066651 filed on Jun. 24, 2014, which claims priority under 35 U.S.C. §119(a) to Japanese Patent Application No. 2013-147636 filed Jul. 16, 2013. The above application is hereby expressly incorporated by reference, in its entirety, into the present application.

### BACKGROUND OF THE INVENTION

1. Field of the Invention

The present invention relates to an imaging device having a laser ranging unit and a three-dimensional-measurement device equipped with the imaging device.

2. Description Related to the Prior Art

An imaging device, such as a digital camera, having a laser ranging unit which radiates a laser beam toward a subject and receives a reflected beam of the laser beam to determine the distance (ranging information) to the subject is known (see JP2004-205222A and JP2001-317915A).

An imaging device described in JP2004-205222A includes an image display unit which displays an image obtained by imaging, an indication unit which indicates arbitrary two points in the image displayed on the image display unit, and a calculation unit which calculates the distance between the indicated two points based on distance information of a laser ranging unit or the like.

The laser ranging unit of JP2004-205222A radiates a laser beam toward the substantially center of an imaging range to measure the distance to the center of an image. Furthermore, JP2004-205222A describes that the radiation direction of the laser beam is variable to allow direct laser ranging of the two points.

An imaging device described in JP2001-317915A constitutes a three-dimensional-measurement device with a calculation device. The calculation device acquires three-dimensional information of a subject by analyzing two images of the subject captured at two different imaging positions (first and second imaging positions) by the imaging device. The calculation device determines the relative position and the relative angle of the imaging device at the first and second imaging positions necessary for acquiring the three-dimensional information of the subject using ranging information obtained by the laser ranging unit of the imaging device.

Although JP2001-317915A describes that the laser ranging unit measures the distance to a plurality of points in the imaging range of the image, the laser ranging unit apparently measures the distance to one point in the imaging range. That is, it can be said that a laser radiation position of the laser ranging unit described in JP2001-317915A is fixed in order to allow ranging of the determined position in the imaging range (the center position in the imaging range).

As described in JP2004-205222A, if the laser radiation position is fixed in order to allow ranging of the determined position in the imaging range, when an object does not exist at the ranging position, a reflected beam of the laser beam is not received, and it is not possible to perform ranging. For example, when a subject (triumphal arch) shown in FIG. 18 is an imaging target, a center position 101 as a laser radiation position in an imaging range 100 becomes a hollow portion of the subject, and the laser beam is not reflected; thus, it is not possible to perform ranging.

Although JP2004-205222A describes that the radiation direction of the laser beam is variable to perform ranging of an arbitrary position of the imaging range, the laser beam cannot be imaged by a general imaging device; thus, it is not possible to specify a laser radiation position from an image obtained by imaging.

Although JP2004-205222A describes that, when the radiation direction of the laser beam is variable, the radiation direction of the laser beam is detected by an angle detector, such as a potentiometer, it is difficult to accurately specify an actual radiation position in the image from the radiation direction.

### SUMMARY OF THE INVENTION

An object of the invention is to provide an imaging device capable of achieving accurate specification of a laser radiation position and a three-dimensional-measurement device equipped with the imaging device.

In order to attain the above-described object, an imaging device of the invention includes a first imaging unit, a laser radiation unit, a laser receiving unit, a second imaging unit, a laser radiation position specification unit, and a distance calculation unit. The first imaging unit images a first range to generate a first image. The laser radiation unit is adapted to radiate a laser beam in an arbitrary direction within the first range. The laser receiving unit receives a reflected beam of the laser beam. The second imaging unit images a second range including the radiation position of the laser beam within the first range to generate a second image. The laser radiation position specification unit searches for a portion matching the second image in the first image to specify the radiation position in the first image. The distance calculation unit calculates the distance to the radiation position specified by the laser radiation position specification unit based on the time of receiving the reflected beam by the laser receiving unit.

It is preferable that an imaging direction of the second imaging unit is changed in conjunction with the laser radiation direction of the laser radiation unit. It is preferable that the first imaging unit and the second imaging unit perform imaging at the same time.

The imaging device may further include an image storage unit which stores the first image, and the radiation position specified by the laser radiation position specification unit may be stored in the image storage unit in association with the first image.

The imaging device may further include a movable reflection mirror which has the same optical axis as those of the second imaging unit and the laser radiation unit and bends the optical axis, and the imaging direction and the laser radiation direction may be changed in conjunction with a change in an angle with respect to the optical axis of the reflection mirror.

In this case, it is preferable that the imaging device further includes an angle detection unit which detects the angle of the reflection mirror, and the laser radiation position specification unit determines, based on the angle detected by the angle detection unit, an initial position for starting to search for a portion matching the second image in the first image.

The imaging device may further include a camera body having the first imaging unit, and a laser ranging unit having the laser receiving unit and the second imaging unit, and the laser ranging unit may be rotatably attached to the camera body. The laser ranging unit having the laser receiving unit and the second imaging unit may be separated from the camera body, and the camera body and the laser ranging unit may perform communication in a wireless manner or the like.

In this case, it is preferable that the imaging device further includes an angle detection unit which detects the angle of the laser ranging unit with respect to the camera body, and the laser radiation position specification unit determines, based on the angle detected by the angle detection unit, an initial position for starting to search for a portion matching the second image in the first image.

A three-dimensional-measurement device of the invention includes the above-described imaging device and a calculation device. The calculation device includes an image analysis unit and a three-dimensional data creation unit. The image analysis unit extracts a plurality of feature points in the first image obtained at a first imaging position by the imaging device and the first image obtained at a second imaging position by the imaging device and calculates the relative position and the relative angle of the imaging device at the first and second imaging positions by performing pattern-matching of the extracted feature points. The three-dimensional data creation unit creates three-dimensional data of a subject based on the first image obtained at the first and second imaging positions and the relative position and the relative angle calculated by the image analysis unit.

In this case, it is preferable that the imaging device searches for a portion matching the second image obtained at the first imaging position in the first image obtained at the second imaging position and gives notification of the search result.

According to the invention, the second imaging unit images the second range including the radiation position of the laser beam within the first range imaged by the first imaging unit to generate the second image, and the laser radiation position specification unit searches for a portion matching the second image in the first image to specify the radiation position in the first image; thus, it is possible to accurately specify the laser radiation position.

According to the invention, the laser beam can be radiated in an arbitrary direction within the first range; thus, it is possible to reliably perform ranging to a subject having a hollow.

### BRIEF DESCRIPTION OF DRAWINGS

For more complete understanding of the present invention, and the advantage thereof, reference is now made to the subsequent descriptions taken in conjunction with the accompanying drawings, in which:

FIG. 1 is a front-side perspective view of a digital camera;

FIG. 2 is a rear view of the digital camera;

FIG. 3 is a block diagram showing the electrical configuration of the digital camera;

FIG. 4 is a diagram illustrating the relationship between first and second imaging ranges;

FIG. 5 is a diagram illustrating a pattern matching method;

FIG. 6 is a flowchart illustrating the action of the digital camera;

FIG. 7 is a diagram illustrating a first image;

FIG. 8 is a diagram illustrating a second image;

FIG. 9 is a block diagram showing the electrical configuration of a digital camera of a second embodiment;

FIG. 10 is a diagram illustrating an initial position and a search region of pattern matching in the second embodiment;

FIG. 11 is a perspective view showing a first modification example regarding an attachment position of a laser ranging unit;

FIG. 12 is a perspective view showing a second modification example regarding the attachment position of the laser ranging unit;

FIG. 13 is a perspective view showing a third modification example regarding the attachment position of the laser ranging unit;

FIG. 14 is a perspective view of a digital camera of a third embodiment;

FIG. 15 is a block diagram showing the electrical configuration of a digital camera of the third embodiment;

FIG. 16 is a schematic view showing the configuration of a three-dimensional-measurement device;

FIGS. 17A and 17B are flowcharts illustrating the action of the three-dimensional-measurement device; and

FIG. 18 is a diagram illustrating a problem in the related art.

### DESCRIPTION OF THE PREFERRED EMBODIMENTS

### First Embodiment

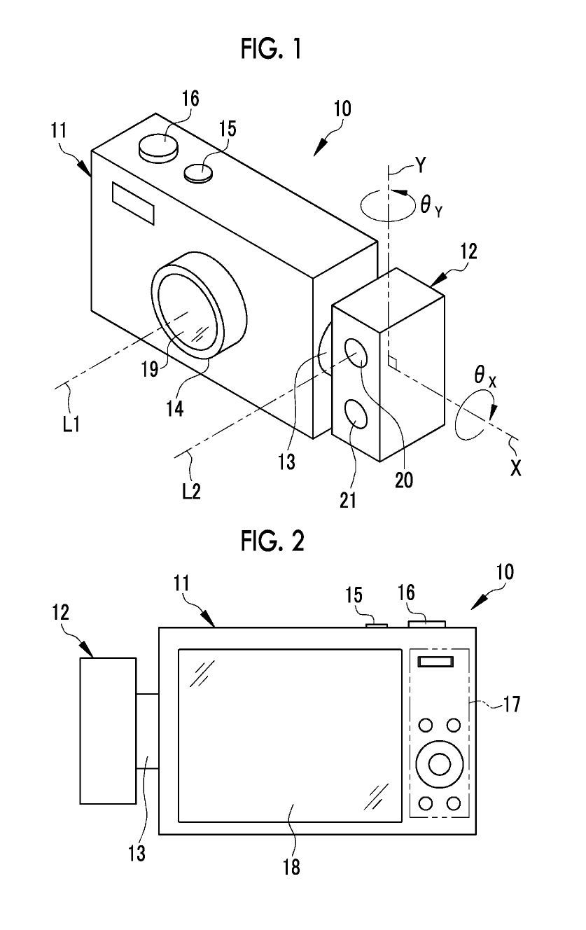

In FIGS. 1 and 2, a digital camera 10 has a camera body 11, a laser ranging unit 12, and a hinge unit 13. The camera body 11 performs imaging of a subject. The laser ranging unit 12 measures the distance to the subject. The hinge unit 13 holds the laser ranging unit 12 so as to be rotatable with respect to the camera body 11. In the camera body 11, a lens barrel 14, a power button 15, a release button 16, a setting operation unit 17, a display unit 18, and the like are provided.

The lens barrel 14 is provided on the front surface of the camera body 11, and holds an imaging lens 19 having one or a plurality of lenses. The power button 15 and the release button 16 are provided on the top surface of the camera body 11. The setting operation unit 17 and the display unit 18 are provided on the rear surface of the camera body 11.

The power button 15 is operated for switching on/off the power supply (not shown) of the digital camera 10. The release button 16 is operated for executing imaging. The setting operation unit 17 has various buttons or dials, and is operated to perform various settings of the digital camera 10 or switching between operation modes.

The operation modes of the digital camera 10 include an imaging mode in which a still image is acquired, a reproduction mode in which a captured image is reproduced and displayed on the display unit 18, a ranging mode in which a still image is acquired and ranging of the subject is performed, and the like. The display unit 18 is constituted of a liquid crystal display or the like, and displays a captured image or a menu screen for performing various settings by the setting operation unit 17.

When the operation mode is set to the imaging mode or the ranging mode, the display unit 18 displays a live view image until imaging is executed. The user can determine a composition while observing the live view image displayed on the display unit 18.

The laser ranging unit 12 is attached to the side of the camera body 11 through the hinge unit 13. The hinge unit 13 holds the laser ranging unit 12 so as to be rotatable with the X axis and the Y axis orthogonal to an optical axis L1 of the imaging lens 19 as rotation axes. The X axis and the Y axis are orthogonal to each other. The user can rotate the laser ranging unit 12 at a desired angle with respect to the camera body 11.

On the entire surface of the laser ranging unit 12, a radiation window 20 through which a laser beam is radiated toward the subject and a light receiving window 21 through which a reflected beam of the laser beam is received are provided. The angles θ_{X} and θ_{Y} between an optical axis L2 of the laser beam radiated from the radiation window 20 and the optical axis L1 of the imaging lens 19 change depending on the rotation of the laser ranging unit 12.

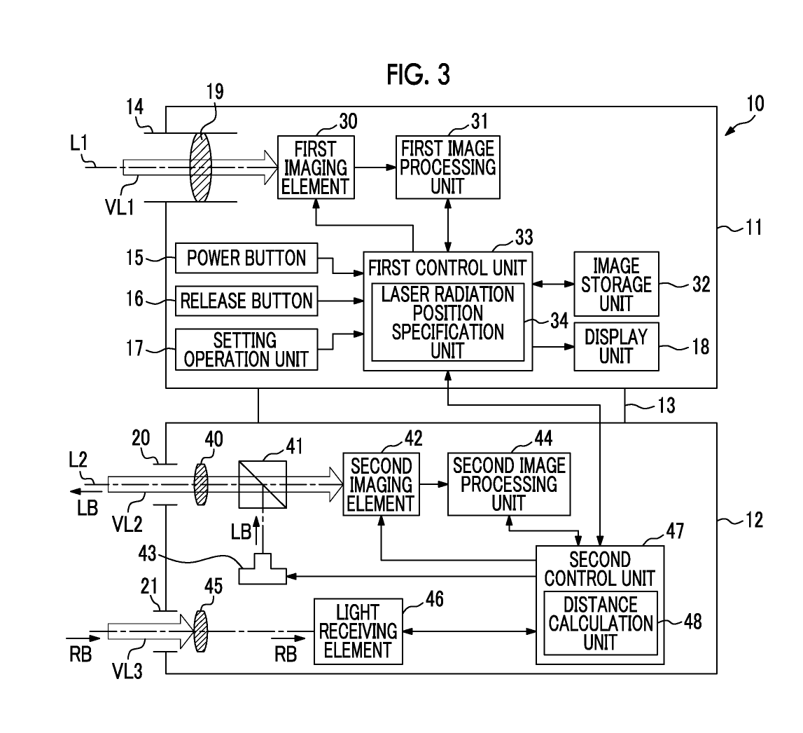

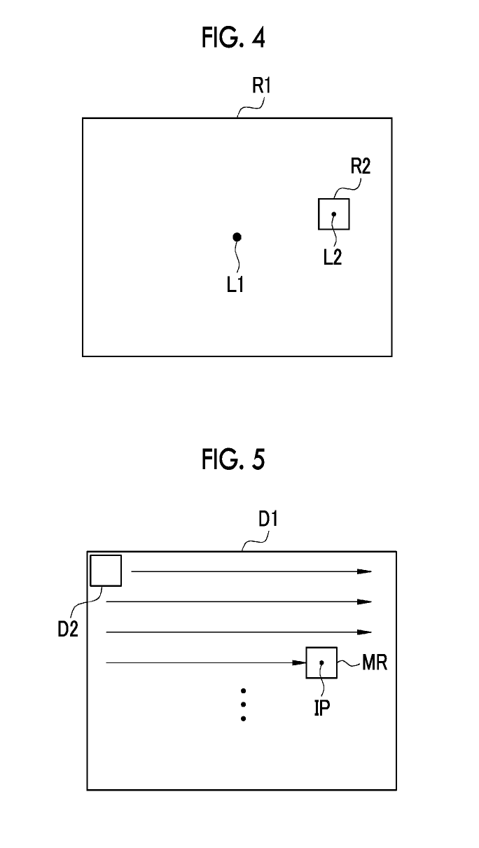

In FIG. 3, inside a first housing constituting the camera body 11, a first imaging element 30, a first image processing unit 31, an image storage unit 32, and a first control unit 33 are provided. The first imaging element 30 is a single-plate color imaging CMOS image sensor or a CCD image sensor, and receives visible light (ambient light) VL1 through the imaging lens 19 and performs imaging to generate image data. The imaging lens 19 and the first imaging element 30 constitute a first imaging unit, and as shown in FIG. 4, image a rectangular first imaging range R1. The optical axis L1 is positioned at the center of the first imaging range R1.

The first image processing unit 31 performs image processing, such as defect correction processing, demosaic processing, gamma correction processing, white balance correction processing, and YC conversion processing, on image data generated by the first imaging element 30. The image storage unit 32 is a nonvolatile memory, such as a flash memory, and stores an image (hereinafter, referred to as a first image D1) subjected to the image processing by the first image processing unit 31.

The first control unit 33 controls the respective units of the camera body 11 according to an operation signal input from the release button 16 or the setting operation unit 17. For example, if the operation mode is set to the imaging mode or the ranging mode by the setting operation unit 17, the first control unit 33 operates the first imaging element 30 and the first image processing unit 31, generates the first image D1 at every predetermined time, and sequentially displays the generated first image D1 on the display unit 18. With this, a live view display is performed on the display unit 18. Then, if the release button 16 is depressed, the first image D1 generated by the first imaging element 30 and the first image processing unit 31 at this time is stored in the image storage unit 32.

Inside a second housing constituting the laser ranging unit 12, a first objective lens 40, a dichroic mirror 41, a second imaging element 42, a laser light source 43, a second image processing unit 44, a second objective lens 45, a light receiving element 46, and a second control unit 47 are provided. The laser light source 43, the dichroic mirror 41, and the first objective lens 40 constitute a laser radiation unit. The second objective lens 45 and the light receiving element 46 constitute a laser receiving unit.

The first objective lens 40, the dichroic mirror 41, and the second imaging element 42 are arranged behind the above-described radiation window 20 along the optical axis L2. The laser light source 43 is arranged in a direction orthogonal to the optical axis L2 from the dichroic mirror 41. The first objective lens 40 has one or a plurality of lenses. The dichroic mirror 41 has optical characteristics of transmitting visible light and reflecting a laser beam. As the dichroic mirror 41, for example, a single edge dichroic beam splitter having an edge wavelength of about 400 nm is used.

The laser light source 43 is, for example, a semiconductor laser, and emits a pulsed laser beam LB toward the dichroic mirror 41. The laser beam LB is reflected in a direction toward the first objective lens 40 by the dichroic mirror 41. The laser beam LB reflected by the dichroic mirror 41 propagates along the optical axis L2, passes through the first objective lens 40, and is emitted from the radiation window 20.

The second imaging element 42 receives visible light (ambient light) VL2 incident from the radiation window 20 and transmitted through the first objective lens 40 and the dichroic mirror 41 and performs imaging to generate image data. The second image processing unit 44 performs the same image processing as the above-described first image processing unit 31 on image data generated by the second imaging element 42. An image (hereinafter, referred to as a second image D2) subjected to the image processing by the second image processing unit 44 is sent to the camera body 11 by the second control unit 47.

The first objective lens 40 and the second imaging element 42 constitute a second imaging unit. The angle of view of the second imaging unit is smaller than the angle of view of the above-described first imaging unit. Accordingly, as shown in FIG. 4, the second imaging unit images a second imaging range R2 smaller than the first imaging range R1. The optical axis L2 is a radiation optical axis of the laser beam LB and a light receiving optical axis of visible light VL2, and is positioned at the center of the second imaging range R2. That is, the radiation position of the laser beam LB is the center of the second imaging range R2.

The radiation direction of the laser beam LB and the imaging direction of the second imaging unit are the same direction, and are changed according to the rotation of the laser ranging unit 12 with respect to the camera body 11.

The second objective lens 45 has one or a plurality of lenses, and is arranged behind the second objective lens 45. The light receiving element 46 receives a reflected beam RB of the laser beam LB reflected by the subject through the second objective lens 45. The light receiving element 46 is constituted of a photodiode having light receiving sensitivity for a wavelength band of a laser beam. It is preferable that the second objective lens 45 is able to transmit to a laser beam, and is unable to transmit to visible light (ambient light) VL3 incident on the second objective lens 45.

The second control unit 47 performs communication with the first control unit 33 and controls the respective units of the laser ranging unit 12. The second control unit 47 is provided with a distance calculation unit 48. The distance calculation unit 48 measures the time (the reciprocation time of the laser beam LB) until the laser beam LB emitted from the laser light source 43 is reflected by the subject and received as the reflected beam RB by the light receiving element 46, and calculates the distance (hereinafter, referred to as distance information) from the digital camera 10 to the subject (laser radiation position) based on the measured value.

The second control unit 47 drives the second imaging element 42 and the second image processing unit 44 to acquire the second image D2 at the same time as driving the laser light source 43, the light receiving element 46, and the distance calculation unit 48 to execute laser ranging. Accordingly, the second image D2 is image information obtained by imaging a local region around the radiation position during the radiation of the laser beam LB. The second image D2 is sent to the first control unit 33 along with the distance information.

In the ranging mode, the first control unit 33 performs control such that the second control unit 47 acquires the second image D2 and the distance information at the same time as the first imaging element 30 and the first image processing unit 31 are operated to acquire the first image D1. The same time includes a case where the time is completely the same and a case where the time is not completely the same but substantially the same.

The first control unit 33 is provided with the laser radiation position specification unit 34. As shown in FIG. 5, the laser radiation position specification unit 34 searches for a region (hereinafter, referred to as a matching region MR) matching the second image D2 in the first image D1 using a pattern matching method, such as normalized correlation, and specifies the center of the matching region MR as a laser radiation position IP. Specifically, the laser radiation position specification unit 34 calculates the degree of correlation of the second image D2 and a portion of the first image D1 overlapping the second image D2 while moving the second image D2 in order in the first image D1, and specifies a portion having the highest degree of correlation as the matching region MR.

The first control unit 33 stores the distance information obtained by the distance calculation unit 48 and the laser radiation position obtained by the laser radiation position specification unit 34 in the image storage unit 32 in association with the first image D1. The distance information and the laser radiation position may be saved as a single file with the first image D1, or may be saved as a different file associated with the first image D1. The first control unit 33 adds the distance information and the laser radiation position to the second image D2 as image associated information in compliance with, for example, the Exif standards, and stores the second image D2 with the distance information and the laser radiation position in the image storage unit 32 as a single file.

When the subject does not sufficiently reflect the laser beam LB and the light receiving element 46 cannot receive the reflected beam RB, or when a region matching the second image D2 is not found in the first image D1 and the laser radiation position cannot be specified, the first control unit 33 displays a display (error message) on the display unit 18 to the effect that laser ranging is not performed normally.

The first control unit 33 performs laser ranging periodically during display of the live view image in the ranging mode, and displays the laser radiation position and the distance information in the live view image.

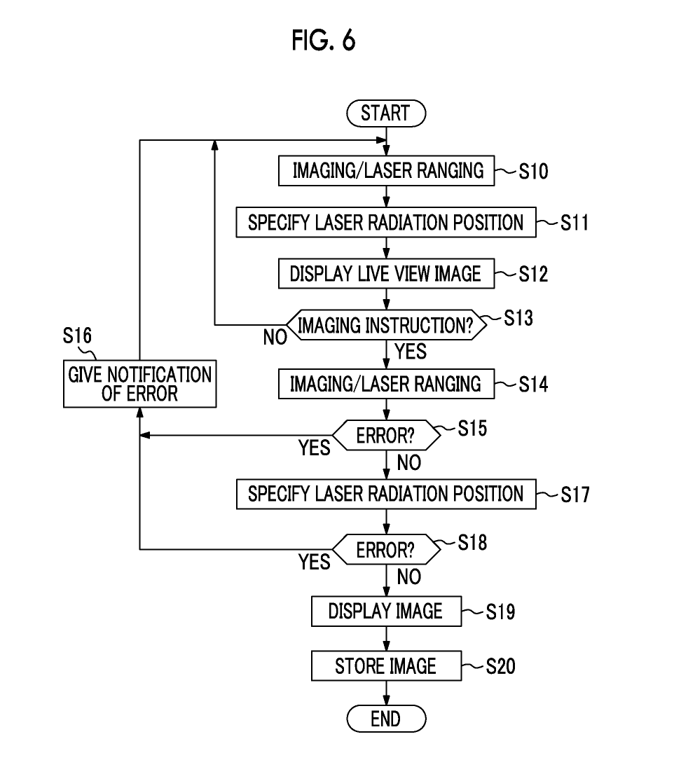

Next, the action of the digital camera 10 will be described along with the flowchart of FIG. 6. If the setting operation unit 17 is operated by the user and the operation mode is set to the ranging mode, an imaging operation of a live view image is performed by the camera body 11, and a laser ranging operation is performed by the laser ranging unit 12 (Step S10).

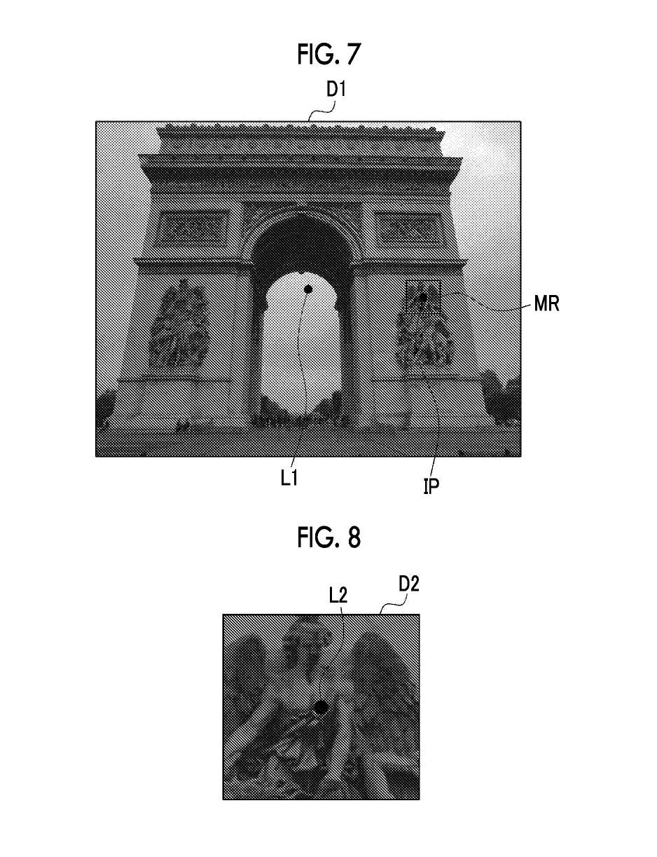

In Step S10, the first and second images D1 and D2 and the distance information described above are acquired. FIG. 7 illustrates the first image D1 obtained by the camera body 11. FIG. 8 illustrates the second image D2 acquired by the laser ranging unit 12.

Then, pattern matching is performed using the first and second images D1 and D2 by the laser radiation position specification unit 34, and the matching region MR matching the second image D2 is detected in the first image D1, whereby the laser radiation position IP is specified (Step S11).

The first image D1 is displayed on the display unit 18 as a live view image (Step S12). At this time, in the first image D1, the display of the laser radiation position IP specified in Step S11 is performed. The user determines a composition while observing the live view image, and adjusts the angle of the laser ranging unit 12 with respect to the camera body 11, thereby changing the laser radiation position IP. The laser radiation position IP can be confirmed on the live view image. For example, when the live view display of the first image D1 shown in FIG. 7 is performed, the user can set the laser radiation position IP at a position where an object exists while confirming the laser radiation position IP in the first image D1.

The operation of Steps S10 to S12 is repeatedly executed until the release button 16 is depressed by the user and an imaging instruction is issued. If the release button 16 is depressed and the imaging instruction is issued (the determination in Step S13 is YES), the same imaging operation and laser ranging operation as in Step S10 are performed (Step S14). At this time, when laser ranging is not performed normally since the light receiving element 46 cannot receive the reflected beam RB (the determination in Step S15 is YES), the display of the error message on the display unit 18 is performed (Step S16).

When laser ranging is performed normally (the determination in Step S15 is NO), the same specification operation of the laser radiation position as in Step S11 is performed (Step S17). At this time, when the laser radiation position cannot be specified since a region matching the second image D2 is not found in the first image D1 (the determination in Step S18 is YES), the display of the error message on the display unit 18 is performed (Step S16).

When the laser radiation position is specified normally (the determination in Step S18 is NO), the first image D1 is displayed on the display unit 18, and the laser radiation position and the distance information are displayed in the first image D1 (Step S19). Then, the first image D1 is attached with the distance information and the laser radiation position as image associated information, and is stored in the image storage unit 32 (Step S19).

In this way, the user adjusts the angle of the laser ranging unit 12, whereby laser ranging is performed at a desired position within the first imaging range R1, and the laser radiation position within the first image D1 can be accurately ascertained.

In the foregoing first embodiment, although laser ranging and the acquisition of the first and second images D1 and D2 are executed at the same time, the acquisition of the first and second images D1 and D2 may be executed after laser ranging is completed normally.

In the foregoing first embodiment, although, when laser ranging is not performed normally and when the laser radiation position cannot be specified, the error message is displayed on the display unit 18 to give error notification, error notification may be given by sound, turning on of an indicator lamp, or the like.

In the foregoing first embodiment, although the distance calculation unit 48 is provided in the laser ranging unit 12, the distance calculation unit 48 may be provided in the camera body 11, or the distance calculation unit 48 may be provided outside the camera body 11.

### Second Embodiment

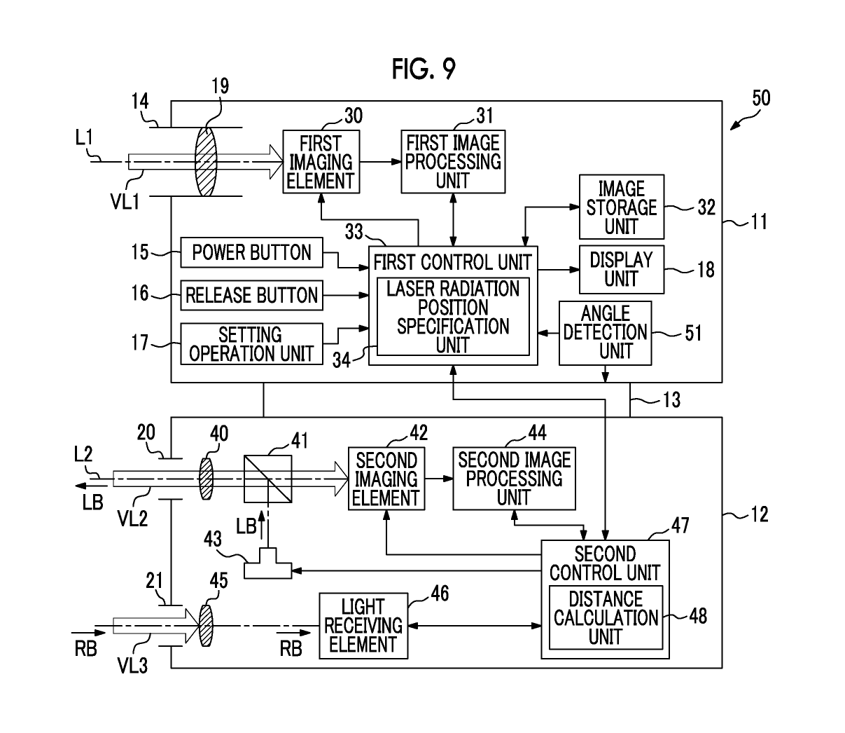

In FIG. 9, a digital camera 50 of a second embodiment includes an angle detection unit 51 which detects the angle of the laser ranging unit 12 with respect to the camera body 11 (that is, the angles θ_{X} and θ_{Y} between the optical axis L1 and the optical axis L2). The angle detection unit 51 supplies the detected angles θ_{X} and θ_{Y} to the laser radiation position specification unit 34. The angle detection unit 51 is constituted of a potentiometer or the like.

In this embodiment, the laser radiation position specification unit 34 determines a rough position of the laser radiation position in the first image D1 based on the angles θ_{X} and θ_{Y} detected by the angle detection unit 51, and the position is set as an initial position for performing matching of the pattern of the second image D2 to the first image D1.

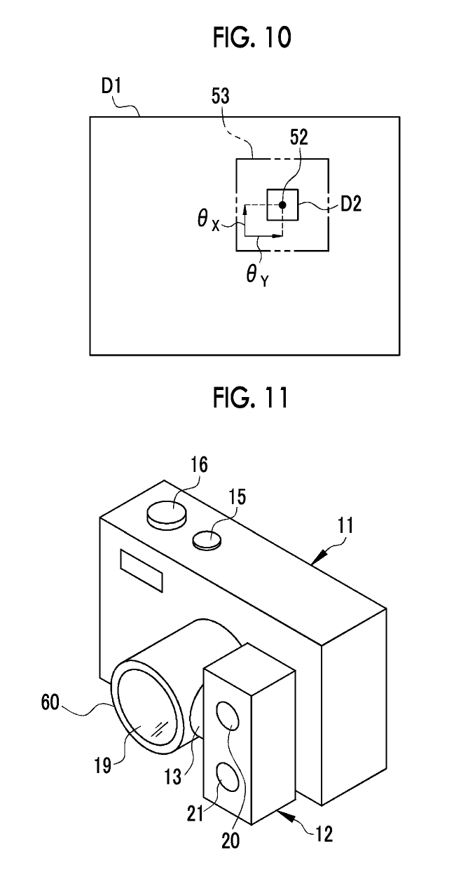

Specifically, as shown in FIG. 10, the laser radiation position specification unit 34 calculates the rough position (initial position 52) of the laser radiation position in the first image D1 based on the ratio of the angles θ_{X} and θ_{Y} to the angle of view of the first imaging range R1. Then, the laser radiation position specification unit 34 sets a search region 53 around the initial position 52 in the first image D1, and performs pattern matching while moving the second image D2 from the initial position 52 in the search region 53. Since other configurations of this embodiment are the same as those in the first embodiment, these configurations are represented by the same reference numerals, and descriptions thereof will not be repeated.

In this embodiment, since a region where pattern matching is performed is limited, it is possible to perform the specification of the laser radiation position with high accuracy and at high speed.

In this embodiment, although the angle detection unit 51 detects the angles θ_{X} and θ_{Y} around the X axis and the X axis, the angle detection unit 51 may detect only one angle, and a region where pattern matching is performed may be limited to only one detected angular direction.

In the foregoing first and second embodiments, although the laser ranging unit 12 is attached to the side of the camera body 11 through the hinge unit 13, the attachment place of the laser ranging unit 12 can be appropriately changed. For example, as shown in FIG. 11, a detachable interchangeable lens barrel 60 may be provided in the camera body 11, and the laser ranging unit 12 may be attached to the side of the interchangeable lens barrel 60 through the hinge unit 13.

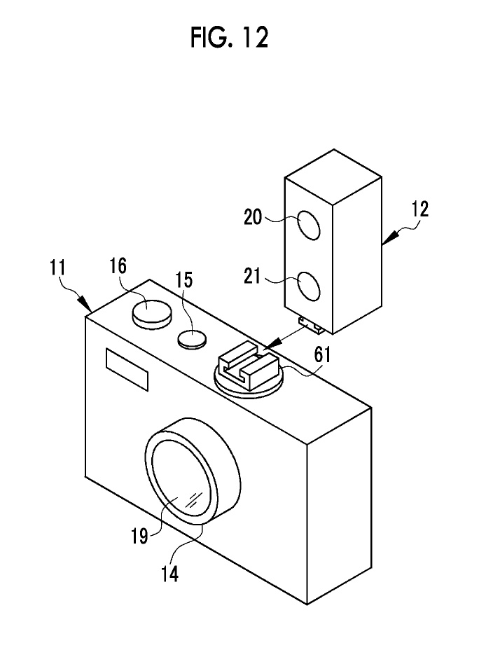

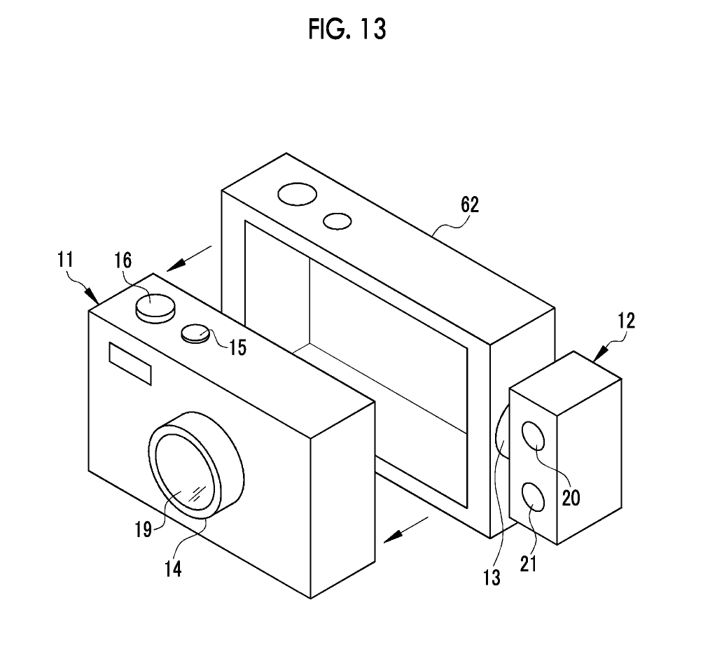

As shown in FIG. 12, an accessory shoe 61 for attachment of a flash unit or the like may be provided on the top surface of the camera body 11, and the laser ranging unit 12 may be detachably attached to the accessory shoe 61. In this case, the accessory shoe 61 functions as the above-described hinge unit. Furthermore, as shown in FIG. 13, the laser ranging unit 12 may be attached to a jacket 62 which is attachable and detachable to and from the camera body 11. The jacket 62 is attached so as to cover the outer peripheral surface of the camera body 11.

The laser ranging unit 12 may be independently separated from the camera body 11, and the laser ranging unit 12 and the camera body 11 may perform communication with each other in a wireless manner or the like.

### Third Embodiment

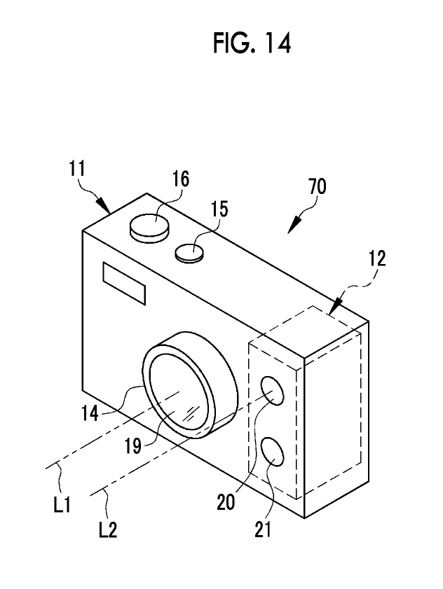

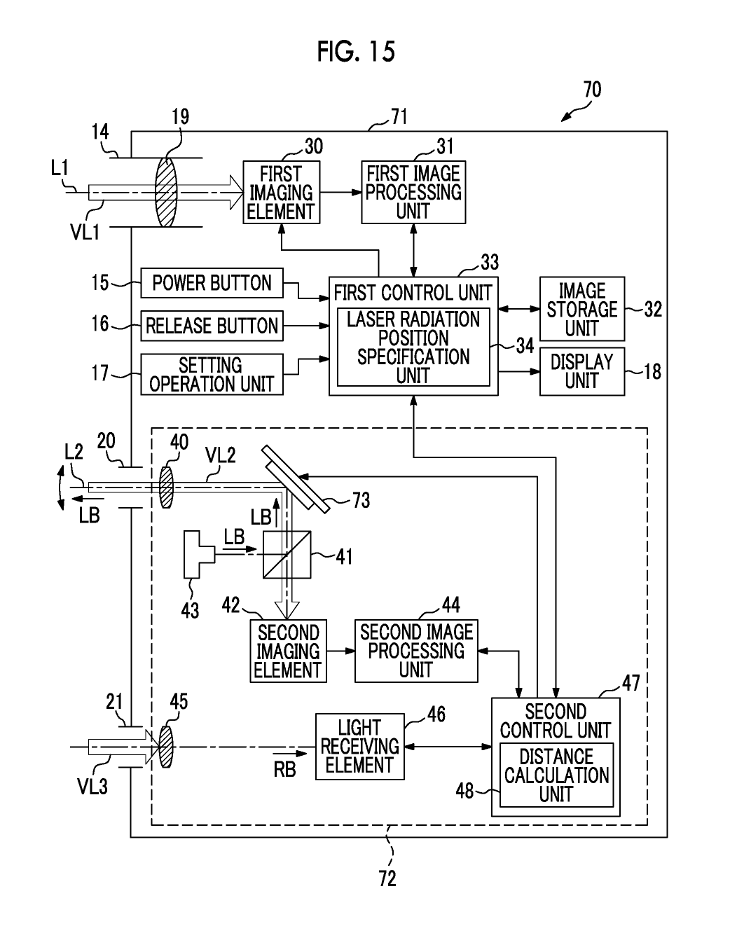

In FIGS. 14 and 15, a digital camera 70 of a third embodiment is provided with a laser ranging unit 72 in a camera body 71. The camera body 71 has the same configuration as the camera body 11 of the first embodiment. The laser ranging unit 72 has a configuration different from the configuration of the laser ranging unit 12 of the first embodiment only in that a reflection mirror 73 is provided between the first objective lens 40 and the dichroic mirror 41, and the optical axis L2 is bent by the reflection mirror 73.

The reflection mirror 73 is a mirror device having a movable reflection surface, and is, for example, a digital mirror device (DMD). The reflection mirror 73 changes the inclination angle of the reflection surface and the direction of the optical axis L2 under the control of the second control unit 47. The radiation direction of the laser beam LB and the position of the second imaging range R2 are changed in conjunction with a change in the optical axis L2.

In this embodiment, the radiation direction of the laser beam LB is changeable through the operation of the setting operation unit 17. The second control unit 47 drives the reflection mirror 73 based on an operation signal from the setting operation unit 17. Since other configurations of this embodiment are the same as those in the first embodiment, these configurations are represented by the same reference numerals, and description thereof will not be repeated.

As in the second embodiment, an angle detector which detects the angle of the reflection mirror 73 may be provided, the rough position of the laser radiation position in the first image D1 may be determined based on the angle detected by the angle detection unit, and the position may be set as the initial position for performing matching of the pattern of the second image D2 to the first image D1.

### Fourth Embodiment

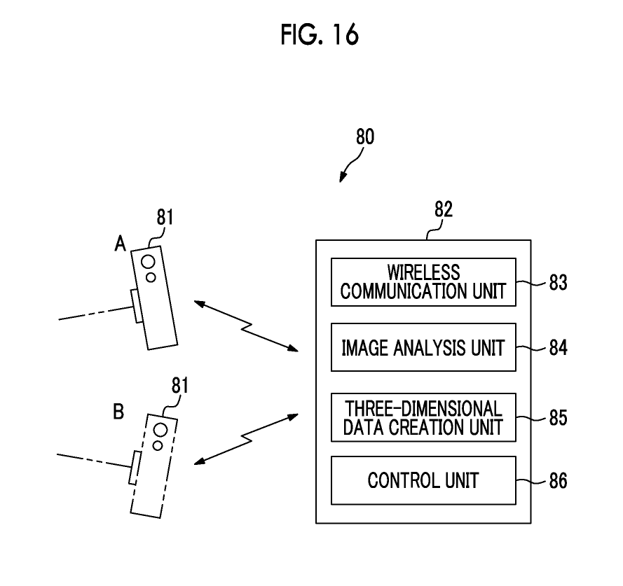

In FIG. 16, a three-dimensional-measurement device 80 includes a digital camera 81, and a calculation device 82 constituted of a personal computer or the like. The digital camera 81 has the same configuration as the digital camera of any one of the foregoing embodiments, and can perform wireless communication with the calculation device 82.

The digital camera 81 performs imaging of the same subject at a first imaging position A and a second imaging position B. The movement of the digital camera 81 between the first imaging position A and the second imaging position B is performed by the user.

The calculation device 82 has a wireless communication unit 83, an image analysis unit 84, a three-dimensional data creation unit 85, and a control unit 86. The wireless communication unit 83 receives first images D1 acquired through imaging at the first and second imaging positions A and B and distance information from the digital camera 81. The wireless communication unit 83 transmits a control signal from the control unit 86 to the digital camera 81.

The image analysis unit 84 extracts a plurality of feature points from the two first images D1 obtained at the first and second imaging positions A and B based on a known eight-point algorithm, and performs pattern matching of the extracted feature points, thereby calculating the relative position and the relative angle of the digital camera 81 at the first and second imaging positions A and B. In this method, since a scale (magnification ratio) is unknown, the image analysis unit 84 determines the scale based on at least the distance information obtained at the first imaging position A.

The three-dimensional data creation unit 85 creates three-dimensional data of the subject based on the first images D1 at the first and second imaging positions A and B and the relative position and the relative angle of the digital camera 81 at the first and second imaging positions A and B using a stereo method. The control unit 86 controls the respective units in the calculation device 82, and the digital camera 81.

The control unit 86 controls the digital camera 81, searches for a region matching a second image D2 obtained at the first imaging position A during live view display for performing imaging at the second imaging position B after imaging is performed at the first imaging position A in the first image D1 obtained at the second imaging position B during live view display, and displays the search result on the display unit 18. With this, the user can easily confirm that a subject at the first imaging position A is the same as that imaged at the second imaging position B.

Similarly, even after imaging is performed at the second imaging position B, the control unit 86 searches for a region matching the second image D2 obtained at the first imaging position A in the first image D1 obtained at the second imaging position B, displays the search result on the display unit 18, and stores the search result in the image storage unit 32 in association with the first image D1. In particular, when a region matching the second image D2 does not exist in the first image D1, the control unit 86 displays a message for requesting re-imaging on the display unit 18.

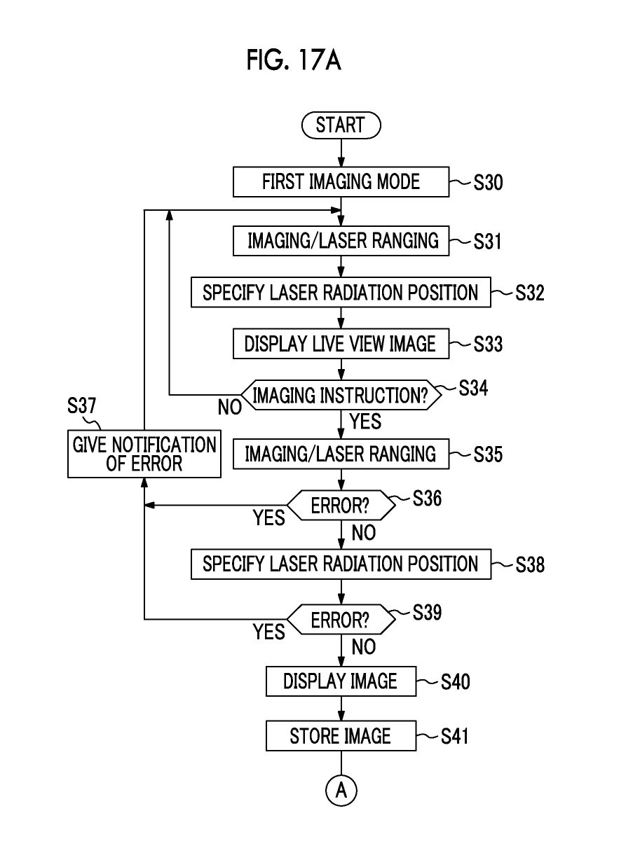

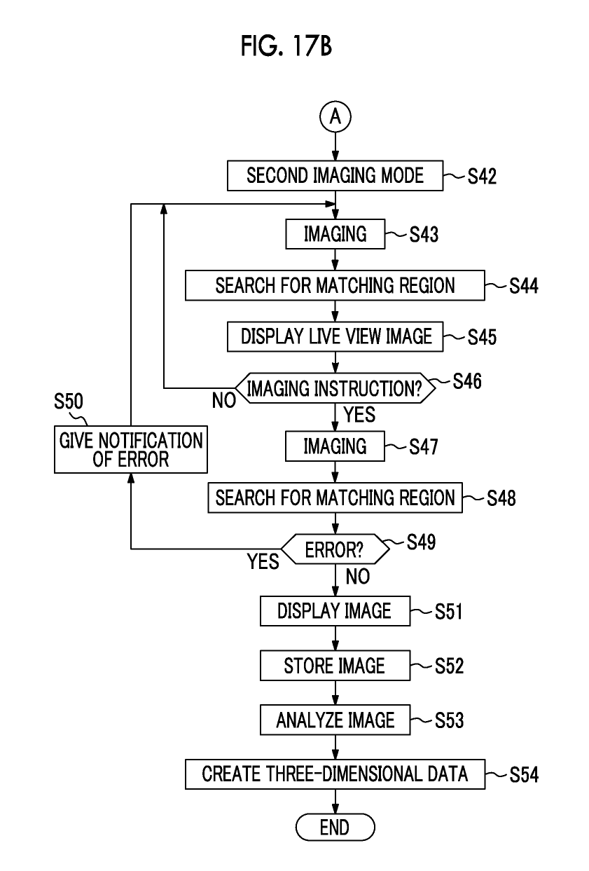

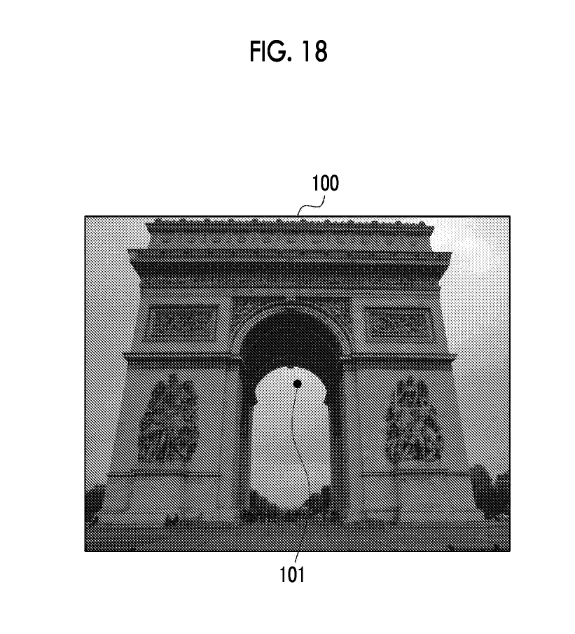

Next, the action of the three-dimensional-measurement device 80 will be described along with the flowcharts of FIGS. 17A and 17B. If the setting operation unit 17 of the digital camera 81 is operated and the digital camera 81 is set in a first imaging mode (Step S30), similarly to the digital camera 10 of the first embodiment, imaging and laser ranging (Step S31), specification of a laser radiation position (Step S32), and live view image display (Step S33) are performed. The user determines a composition while observing the live view image and performs imaging at the first imaging position A.

At the first imaging position A, if the release button 16 is depressed by the user and the imaging instruction is issued (the determination in Step S34 is YES), similarly to the digital camera 10 of the first embodiment, imaging and laser ranging (Step S35), specification of a laser radiation position (Step S38), and the like are performed, and the display of the first image D1 on the display unit 18 (Step S40) and the storage of the first image D1 in the image storage unit 32 (Step S41) are performed.

Next, the user moves the digital camera 81 to the second imaging position B different from the first imaging position A. If the setting operation unit 17 of the digital camera 81 is operated by the user and the digital camera 81 is set in a second imaging mode (Step S42), imaging is performed by the camera body 11, and the first image D1 is acquired (Step S43). In the second imaging mode, laser ranging is not performed, and a search for a region matching the second image D2 obtained in the first imaging mode in the first image D1 obtained in Step S43 is performed (Step S44). Then, the live view display of the first image D1 is performed, and the display of the search result (matching region) is performed (Step S45). The user determines a composition while observing the live view image, and performs imaging at the second imaging position B.

At the second imaging position B, if the release button 16 is depressed by the user and the imaging instruction is issued (the determination in Step S46 is YES), as in Steps S43 and S44, imaging (Step S47) and a search for a matching region (Step S48) are performed. When the matching region is not detected (the determination in Step S49 is YES), a message for requesting re-imaging is displayed on the display unit 18 as error notification (Step S50). When the matching region is detected (the determination in Step S49 is NO), the display of the first image D1 on the display unit 18 (Step S40) and the storage of the first image D1 in the image storage unit 32 (Step S41) are performed.

Thereafter, the relative position and the relative angle of the digital camera 81 at the first and second imaging positions A and B are calculated by the image analysis unit 84 based on the two first images D1 obtained at the first and second imaging positions A and B and the distance information (Step S53). Then, three-dimensional data of the subject is created based on the first images D1 at the first and second imaging positions A and B, and the relative position and the relative angle calculated by the image analysis unit 84 by the three-dimensional data creation unit 85 (Step S54).

In the respective embodiments described above, although a digital camera is illustrated as an imaging device, the invention can be applied to various apparatuses with an imaging function (imaging devices), such as a video camera, a mobile phone with a camera, and a smartphone. The respective embodiments described above can be combined with one another as long as there is no contradiction.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. An imaging device comprising:
a first imaging unit which images a first range to generate a first image;
a laser radiation unit which is adapted to radiate a laser beam in an arbitrary direction within the first range;
a laser receiving unit which receives a reflected beam of the laser beam;
a second imaging unit which images a second range including a radiation position of the laser beam within the first range to generate a second image;
a laser radiation position specification unit which searches for a portion matching the second image in the first image to specify the radiation position in the first image; and
a distance calculation unit which calculates the distance to the radiation position specified by the laser radiation position specification unit based on the time of receiving the reflected beam by the laser receiving unit.

2. The imaging device according to claim 1,
wherein an imaging direction of the second imaging unit is changed in conjunction with the laser radiation direction of the laser radiation unit.

3. The imaging device according to claim 2,
wherein the first imaging unit and the second imaging unit perform imaging at the same time.

4. The imaging device according to claim 3, further comprising:
an image storage unit which stores the first image,
wherein the radiation position specified by the laser radiation position specification unit is stored in the image storage unit in association with the first image.

5. The imaging device according to claim 2, further comprising:
a movable reflection mirror which has the same optical axis as those of the second imaging unit and the laser radiation unit, and bends the optical axis,
wherein the imaging direction and the laser radiation direction are changed in conjunction with a change in an angle with respect to the optical axis of the reflection mirror.

6. The imaging device according to claim 5, further comprising:
an angle detection unit which detects the angle of the reflection mirror,
wherein the laser radiation position specification unit determines, based on the angle detected by the angle detection unit, an initial position for starting to search for a portion matching the second image in the first image.

7. The imaging device according to claim 2, further comprising:
a camera body having the first imaging unit; and
a laser ranging unit having the laser receiving unit and the second imaging unit,
wherein the laser ranging unit is rotatably attached to the camera body.

8. The imaging device according to claim 7, further comprising:
an angle detection unit which detects the angle of the laser ranging unit with respect to the camera body,
wherein the laser radiation position specification unit determines, based on the angle detected by the angle detection unit, an initial position for starting to search for a portion matching the second image in the first image.

9. A three-dimensional-measurement device comprising:
A. an imaging device including:
a first imaging unit which images a first range to generate a first image;
a laser radiation unit which is adapted to radiate a laser beam in an arbitrary direction within the first range;
a laser receiving unit which receives a reflected beam of the laser beam;
a second imaging unit which images a second range including a radiation position of the laser beam within the first range to generate a second image;
a laser radiation position specification unit which searches for a portion matching the second image in the first image to specify the radiation position in the first image; and
a distance calculation unit which calculates the distance to the radiation position specified by the laser radiation position specification unit based on the time of receiving the reflected beam by the laser receiving unit; and
B. calculation device including:
an image analysis unit which extracts a plurality of feature points in the first image obtained at a first imaging position by the imaging device and the first image obtained at a second imaging position by the imaging device, and calculates the relative position and the relative angle of the imaging device at the first and second imaging positions by performing pattern-matching of the extracted feature points; and
a three-dimensional data creation unit which creates three-dimensional data of a subject based on the first image obtained at the first and second imaging positions and the relative position and the relative angle calculated by the image analysis unit.

10. The three-dimensional-measurement device according to claim 9,
wherein the imaging device searches for a portion matching the second image obtained at the first imaging position in the first image obtained at the second imaging position and gives notification of the search result.
